(19) United States
(12) Patent Application Publication
(10) Pub. No.: US 2009/0180391 A1
(43) Pub. Date: Jul. 16, 2009

(54) NETWORK ACTIVITY ANOMALY DETECTION

(75) Inventors: Brian Petersen, San Francisco, CA (US); Edgar Chung, Mountain View, CA (US)

Correspondence Address: BRAKE HUGHES BELLERMANN LLP;c/o CPA Global, P.O. Box 52050, Minneapolis, MN, 55402, US

(73) Assignee: BROADCOM CORPORATION, Irvine, CA (US)

(21) Appl. No.: 12/015,387

(22) Filed: Jan. 16, 2008

(51) Int. Cl. G06F 11/00

(52) U.S. Cl. 370/252

(57) ABSTRACT

A method for determining whether anomalous activity exists on a network includes receiving a packet from the network, the packet including one or more fields. A classification of the packet based on the one or more fields is determined. A first counter of one or more counters associated with detecting the anomalous activity is incremented based on the classification. An activity metric associated with the one or more counters is determined based on the incrementing, wherein the activity metric is anticipated to fall within a threshold. Whether the anomalous activity exists on the network is determined based on whether the activity metric falls within the threshold.

### TECHNICAL FIELD

This description relates to network activity detection.

### BACKGROUND

With the growth and expansion of computer and telecommunication technologies, networks have become an integral part of many businesses and serve as the backbone for various economies across the globe. Network reliability (e.g., availability, operability and/or efficiency) may be an important feature in determining the usefulness of a network, because if a network stops functioning reliably or begins responding too slowly, this may alienate potential users and diminish the usefulness of the network. Network reliability may be adversely affected by any number of factors, including, for example, malicious attacks by viruses and/or spyware; packet traffic volume changes caused by an unexpected and unsupportable increase in traffic volume; broken or otherwise malfunctioning equipment and/or denial of service attacks.

To defend against malicious attacks (e.g., virus and spyware) on a network, the network may include or otherwise be armed with an anti-virus program which may scan the body of a packet to determine whether the code or data inside the packet matches a template or ‘signature’ of a known virus or spyware. Then, for example, the anti-virus program may isolate, fix and/or quarantine any suspicious or otherwise confirmed infected (e.g., malicious) packets. Thus, anti-virus programs may be able to detect malicious network packets that match known viral signatures.

However, larger than anticipated increases and/or decreases in the volume of packets (including both malicious and/or non-malicious, e.g., valid packets) transmitted on a network may go undetected by an anti-virus program configured to search for known malicious templates within packets. Such volume spikes or drops may be indicators of other network issues to be addressed to ensure proper network functionality. For example, a rapid and overwhelming increase in the volume of valid (e.g., non-malicious) packets on a network may be an indicator of a denial of service attack that may be trying to disable or otherwise hamper at least a portion of the network with an overwhelming volume of packets. As another example, large drops in expected or anticipated network activity (e.g., number and/or type of packets transmitted on a network) may indicate a defective network device. Early detection and response to such spikes and/or drops in network activity may help increase network reliability.

### SUMMARY

A system and/or method for communicating information, substantially as shown in and/or described in connection with at least one of the figures, as set forth more completely in the claims.

### BRIEF DESCRIPTION OF THE DRAWINGS

FIG. 1 is a block diagram of an example embodiment of a system for network activity anomaly detection.

FIG. 2 is a data flow diagram that illustrates an example embodiment of communication in the system 100 of FIG. 1.

FIG. 3 is a flowchart illustrating example operations of the system of FIG. 1.

FIG. 4 is a flowchart illustrating example operations of the system of FIG. 1.

### DETAILED DESCRIPTION

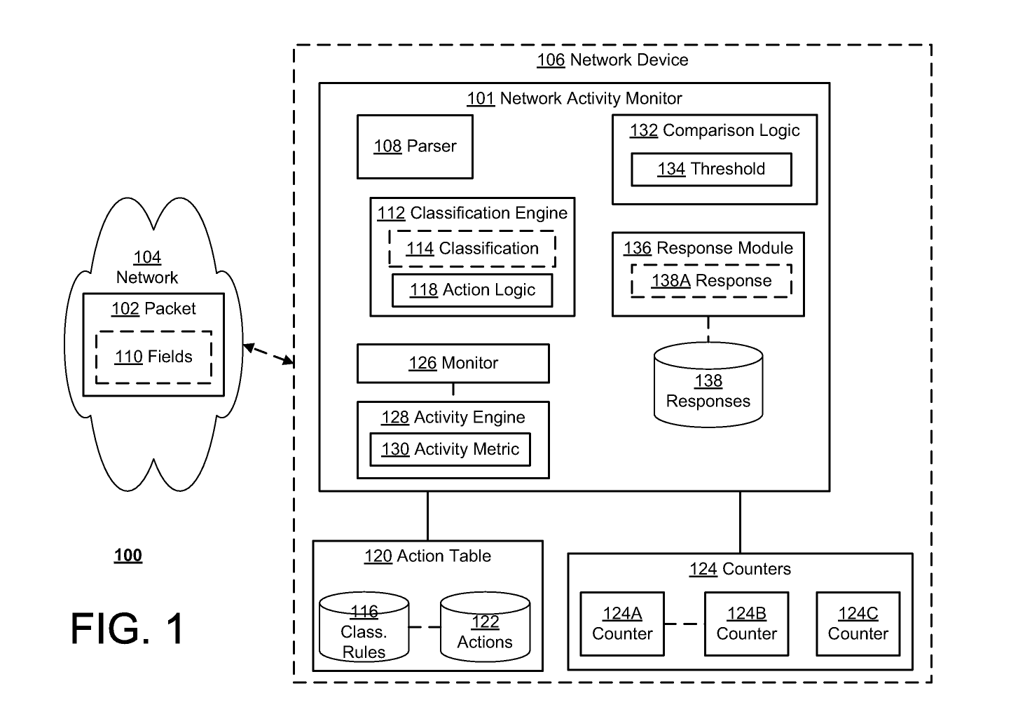

FIG. 1 is a block diagram of an example embodiment of a system 100 for network activity anomaly detection. In the example of FIG. 1, the system 100 may include a network activity monitor 101 configured to receive packets (e.g., packet 102) from a network 104, whereby the network activity monitor 101 may determine, based on the incoming packets, whether or not anomalous activity may be occurring or may have occurred on the network 104. The network activity monitor 101 may, for example, compare actual network activity on the network 104, as determined from the incoming packets 102, to a baseline or anticipated network activity to determine whether the actual network activity is within a range of expected or anticipated activity. If, for example, the actual network activity varies from the baseline activity beyond an expected range of deviation, the network activity monitor 101 may determine and/or perform one or more steps anticipated to minimize the impact of the unexpected (e.g., actual) network activity detected.

The packet 102 may include a formatted block of data that may be transmitted between two or more nodes on one or more networks. The packet 102 may comprise, for example, two or more portions including a header portion with control information and a body (e.g., payload) portion of data. The control information of the header portion may include, for example, source and destination addresses, error detection codes such as, for example, checksums, sequencing information, and/or other information associated with the processing and/or transmission of the packet 102. The body portion may include the data being transmitted via the packet 102.

Wherein traditional anti-virus programs may access the body of the packet 102 to detect viral fingerprints or signatures which may have infected or otherwise be present in the packet, the system 100 may focus on accessing the header portion so as to classify the packet 102 to determine whether anomalous activity exists on the network 104, as will be discussed in greater detail below. Processing only the header of the packet 102, in lieu of and/or in addition to the body, may allow the system 100 to process the packet 102 in less time and/or with fewer resources than may be needed by the system 100 were it to process the body of the packet 102 in addition to and/or in lieu of the header.

The network 104 may include an interconnection of one or more computers, networks or other network devices. For example, the network 104 may include a wireless network, wired network, the Internet, an intranet and/or one or more connected networks. The network 104 may, for example, be used to transmit one or more packets 102 to/from a network device 106.

The network device 106 may include any node, code or device configured to communicate with one or more other nodes via the network 104. The network device 106 may include, for example, a network bridge, router, switch and/or other network device configured to receive and process the packet 102. For example, as referenced above, the network device 106 may receive the packet 102 from a first network (e.g., 104) or network device and transmit or otherwise provide the packet 102 to a second network or network device.

After receipt of the packet 102 from the network 104, a parser 108 may parse the packet 102. The parser 108 may parse the packet 102 into one or more fields 110. For example, as discussed above, the packet 102 may include a header portion and a body portion, wherein each portion may include one or more fields 110. Then for example, the parser 108 may parse the header portion (and/or the body portion) of the packet 102 into the fields 110. According to an example embodiment, parsing just the header for the fields 110, rather than the body, may save on the overall processing time required to process the packet 102 by the system 100.

The fields 110 may include one or more portions of the packet 102 used to store information about the packet 102. The fields 110 of the header portion of the packet may store source, destination and other processing information about the packet 102. In another example embodiment, fields 110 of the body portion of the packet 102 may include the data or other information being transmitted via the packet 102.

A classification engine 112 may classify the packet 102. The classification engine 112 may, for example, determine a classification 114 of the packet 102 based on a comparison of one or more of the fields 110 to classification rules 116.

The classification 114 may include a type, category or other grouping of the packet 102. An example classification 114 may include a determination that the packet 102 is a TCP packet. Or more specifically, the classification 114 may include a determination that packet 102 is a TCP synchronize (SYN) packet, a TCP acknowledgment (ACK) packet, or other TCP packet. In other example embodiments, the classification 114 may include a determination that the packet 102 is another type of packet, other than a TCP packet. Each incoming packet 102 may be classified as any one of a plurality of classifications 114 based on the classification rules 116.

The classification rules 116 may include one or more criteria or rules used to determine the classification 114 of the packet 102. The classification rules 116 may include, for example, various values corresponding to one or more of the fields 110 for determining the classification 114 of the packet 102. For example, the classification rules 116 may state that if the protocol field (e.g., 110) includes the value ‘116’ then the classification 114 may be that the packet 102 is a TCP SYN packet. Or, for example, the classification rules 116 may include classifications corresponding to one or more hash values of one or more fields 110 of the packet 102. Then, for example, the classification engine 112 may hash one or more of the fields 110 of the packet 102 to determine a hash value, which the classification engine 112 may then compare against the classification rules 116 to determine the classification 114. For example, the hash value may be compared to the classification rules 116 to determine to which packet flow the packet 102 belongs. In other example embodiments, multiple values, as determined by the classification engine 112, may correspond to a single classification 114.

Based on the classification 114, action logic 118 may determine, from an action table 120, which of one or more actions 122 are to be performed. The action table 120 may include the classification rules 116 and one or more corresponding actions 122 to be performed based upon the classification 114. For example, the action table 120 may be a database, spreadsheet or other storage for storing the classification rules 116, including corresponding classifications 114 and actions 122. Or for example, the action table 120 may include content-addressable memory (CAM), including a ternary CAM (TCAM), filter processor such as a fast filter processor, associative memory, associative storage, associative array or other memory or data structure that may be used for searching.

The actions 122 may include one or more actions to be performed based on the classification 114 of the packet 102. The actions 122 may include a system response to the classification 114 and/or may be associated with the processing of the packet 102. For example, the actions 112 may include changing the priority of the packet 102, discarding the packet 102, redirecting the packet 102, triggering one or more counters 124 associated with the packet 102 and/or one or more other actions. Then for example, the action logic 118 may determine which of the actions 122 are to be performed based on the classification 114, and may perform, or otherwise signal another component or device, such as the counters 124, to perform the determined action(s) 122.

The counters 124 may include one or more counters 124A, 124B and 124C used to track the receipt and/or processing of one or more packets 102. The counters 124 may be a counting engine, content aware processor and/or fast filter processor. For example, each counter (e.g., 124A-C) may correspond to a different flow or classification 114 of packet 102. A packet flow may include, for example, one or more packets 102 with related or corresponding source, destination, protocol and/or priority information (as determined from the header portion) received within an expected time interval. Then for example, when the classification engine 112 classifies the packet 102, the corresponding counter(s) (e.g., 124A-C) may be incremented based on the actions 122. According to an example embodiment, the counters 124 may measure, track, or otherwise record the rate at which one or more packets 102 are received, the number of packets 102 received within a specified period of time, including the time of last receipt and/or other characteristics associated with the incoming packets 102.

According to an example embodiment, one or more of the counters 124 may be associated with one another. For example, the counter 124A may track how many open-connection packets are received from or transmitted via the network 104 and the counter 124B may track how many close-connection packets are received or transmitted via the network 104. Then for example there may be an association between the counter 124A and 124B wherein their values should be approximately equal, e.g., whereby the number of open-connection packets and close-connection packets detected from the network 104 should be approximately equal within an anticipated range of variance.

According to an example embodiment, the classification 114 may be used to determine a data flow to which the packet 102 belongs. For example, the network activity monitor 101 may track several different flows of packets 102 from the network 104. A flow may correspond, for example, to one or more packet classifications 114. Then for example, when a packet 102 of a particular classification 114 is received, one or more counters 124 may be incremented.

A monitor 126 may monitor the counters 124 for updates. For example, the monitor 126 may monitor the classification engine 112, action logic 118 and/or the counters 124 for one or more counters 124A-C whose values have been incremented or changed. The monitor 126 may for example continuously monitor the counters 124 or periodically check their values. According to an example embodiment, the classification engine 112 and/or counters 124 may signal or otherwise flag the monitor 126 when a counter 126A-C value has been updated or changed responsive to the classification 114 of the packet 102.

The monitor 126 may then signal to an activity engine 128 that one or more of the values of the counters 124A-C have been changed, including for example, which counter 124A-C values changed. The activity engine 128 may then retrieve the values of one or more of the changed or updated counters 124A-C and any associated counters 124A-C. For example, if based on the classification 114 of the packet 102, the counter 124A is updated, then the monitor 126 may signal the activity engine 128 which may retrieve the values from both the counter 124A and the associated counter 124B. Then, for example, the activity engine 128 may use the retrieved values from the counters to generate or otherwise determine an activity metric 130.

The activity metric 130 may include one or more measures of activity on the network 104, as determined based on one or more packets 102. The activity metric 130 may be computed by the activity engine 128 and may include for example a difference between two or more values (e.g., counter 124 values), a ratio of the values or other calculation or comparison of one or more values associated with determining activity on the network 104. For example, as discussed above, the counter 124A may track the number of open-connection packets 102 are received, while the counter 124B may track the number of close-connection packets 102 received. Then, for example, the activity metric 130 may include the ratio of the open-connection packets to close-connection packets received. In example embodiments, the values of the counters 124 may be periodically reset. For example, the counters 124 may be reset every 3 seconds upon access by the activity engine 128, or upon a determination that a packet flow has ended.

Comparison logic 132 may determine whether anomalous activity is occurring, or has occurred on the network 104. The comparison logic 132 may compare the activity metric 130 to a threshold 134 to make the determination. The threshold 134 may include a value, variance, range or other acceptable threshold or expected deviation from an anticipated value of the activity metric 130. The threshold 134 may be different for different activity metrics 130 and may even change or adjust over time. For example, the threshold 134 may include a moving average of expected values for the activity metric 130, which may be different during different periods of time throughout the day. For example, a Monday morning threshold (e.g., 134) for the activity metric 130 may be different from a Saturday night threshold, where more or less activity may be expected or anticipated at different times of day or various times of the year.

According to an example embodiment, the comparison logic 132 may determine the threshold 134 and adjust the threshold 134 over time. For example, as referenced above, the threshold 134 may be a moving average of activity as determined from tracking the activity metric 130 over a period of time. Then for example, based on the incoming packets 102, and the classifications 114 therewith, the comparison logic 132 may calculate and update the threshold 134 over time as the activity metric 130 varies.

The comparison logic 132, as referenced above, may then determine whether or not the activity metric 130 falls within the threshold 134. Based on the comparison, the comparison logic 132 may consequently determine if anomalous activity is occurring or has occurred on the network 104. For example, if the activity metric 130 falls beyond the threshold 134, this may indicate that anomalous activity is occurring on the network 104. Or, for example, if the activity metric 130 falls within the threshold 134, this may indicate normal, expected, or otherwise anticipated activity is occurring on the network 104.

If the comparison logic 132 determines that anomalous activity is occurring on the network 104 (e.g., the activity metric 130 is beyond the threshold 134), then the response module 136 may determine a response 138A from one or more responses 138 to the anomalous network activity. The responses 138 may include one or more responses or actions anticipated to reduce or otherwise mitigate any disruption an elevated (or decreased) level of network activity may cause. The responses 138 may include, for example, notification to a network administrator, shut down of one or more network devices, rate limiting and/or redirection. The responses 138 may be directed towards handling a single packet 102, one or more flows of packets or all activity determined on the network 104.

The responses 138 may also include responses to a determination about the level of network activity detected on the network 104 and/or its variance from the threshold 134. For example, if the activity metric 130 is beyond the threshold 134, then the responses 138 may include discarding the packet 102 and sending a message to a network administrator regarding the network activity exceeding the threshold 134. Or for example, the responses 138 may include different responses based on the extent to which the activity metric 130 exceeds the threshold 134. For example, if the activity metric just exceeds the threshold 134 then a warning message may be transmitted indicating that the threshold 134 has been exceeded. If, however, the activity metric 130 exceeds the threshold 134 by a larger amount, then the responses 134 may include shutting down or otherwise restricting one or more devices on the network 104, including the network device 106. In other example embodiments, the responses 138 may include additional and/or different responses to varying situations.

The response module 136 may then, based on the comparison logic 132, determine which response(s) 138A is/are appropriate given the current level of network activity in comparison to the threshold 134. The response module 136 may then either perform the response 138A and/or signal to the appropriate device or component to perform the response 138A.

As just referenced, the system 100 may allow for the detection of anomalous activity on one or more networks (e.g., 104). The system 100 may determine the presence of anomalous activity based on one or more measures of packets 102 being transmitted on the network in comparison to expected levels of activity. Then, for example, the system 100 may determine the appropriate response to the anomalous activity as soon as it is detected thus preventing or otherwise limiting the interference of the anomalous activity to the functionality of the network 104. This may allow for example, faster detection and response times to network activity by valid (e.g., non-virus infected packets) packets 102, as the components of the system 100 may be encoded within hardware or circuitry of one or more network devices 106. One particular example may be the detection of denial of service attacks that may attempt to artificially spike network activity beyond the threshold 134. However, the system 100 may be used in detecting and responding to other anomalous activity as well.

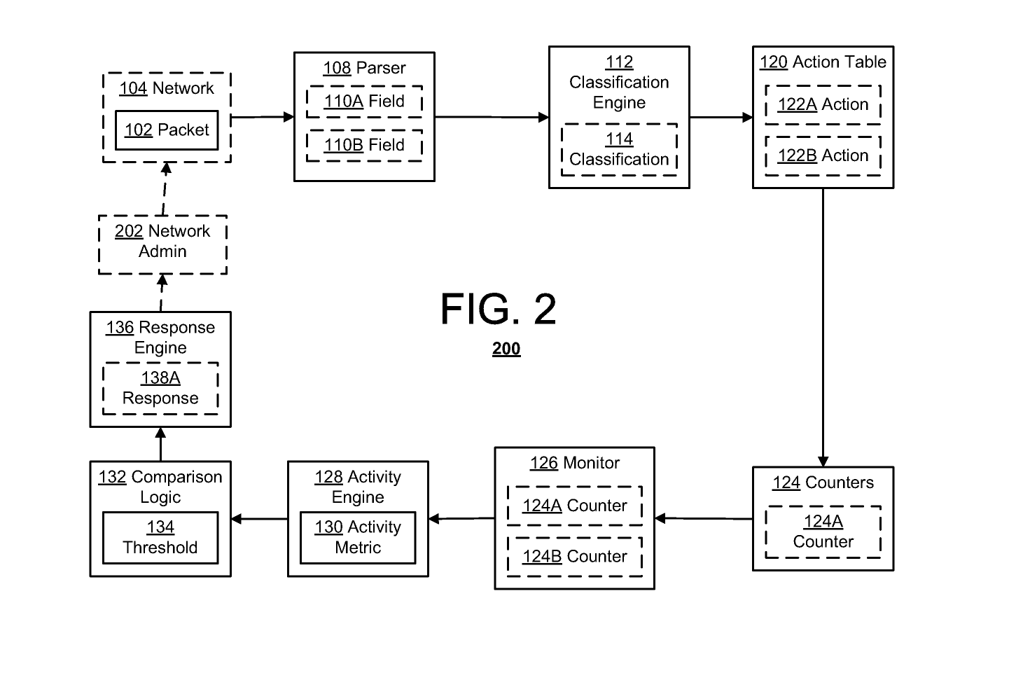

FIG. 2 is a data flow diagram 200 that illustrates an example embodiment of communication in the system 100 of FIG. 1. While FIG. 2 illustrates an example flow diagram 200 representing example operations related to the system 100 of FIG. 1, it should be appreciated however that the data flow diagram 200 is not limited to the example of system 100 and may be applied to other systems. It may also be appreciated that different systems, including the system 100, may have other data flow diagrams in addition to and/or in lieu of the flow diagram 200.

Referring to FIG. 2, the packet 102 may be received from the network 104. The parser 108 may then parse the header of the packet 102 into the fields 110A and 110B. Then, for example, based on the fields 110A and 110B, the classification engine 112 may determine the classification 114 of the packet 102. Based on the classification 114, the actions 122A and 122B may be determined to be performed from the action table 120. For example, the action logic 118 may determine and perform the actions 122A and 122B which may include incrementing the counter 124A. Then for example, the counter 124A of the counters 124 may be incremented based on the actions 122A and/or 122B.

The monitor 126 may detect or otherwise determine that the counter 124A has been incremented, wherein the counters 124A and 124B are associated with one another. Then, for example, the activity engine 128 may determine the values from the associated counters 124A and 124B to calculate or otherwise generate the activity metric 130.

The comparison logic 132 may compare the activity metric 130 to the threshold 134 to determine whether or not anomalous activity exists (or existed) on the network 104. Then for example, if the activity metric exceeds the threshold 134, the response engine 136 may determine a response 138A to the activity.

The response 138A may include, for example, sending a message to a network administrator 202 regarding the network activity. The network administrator 202 may include one or more persons or devices responsible for controlling one or more parts of the network 104. For example, the network administrator 202 may be notified when it is determined that the activity metric 130 exceeds the threshold 134. Then for example, the network administrator 202 may further monitor the network 104 and determine the proper response to the detected anomalous network activity. Then for example, the data flow diagram 200 of FIG. 2 may be repeated for subsequent incoming packets 102.

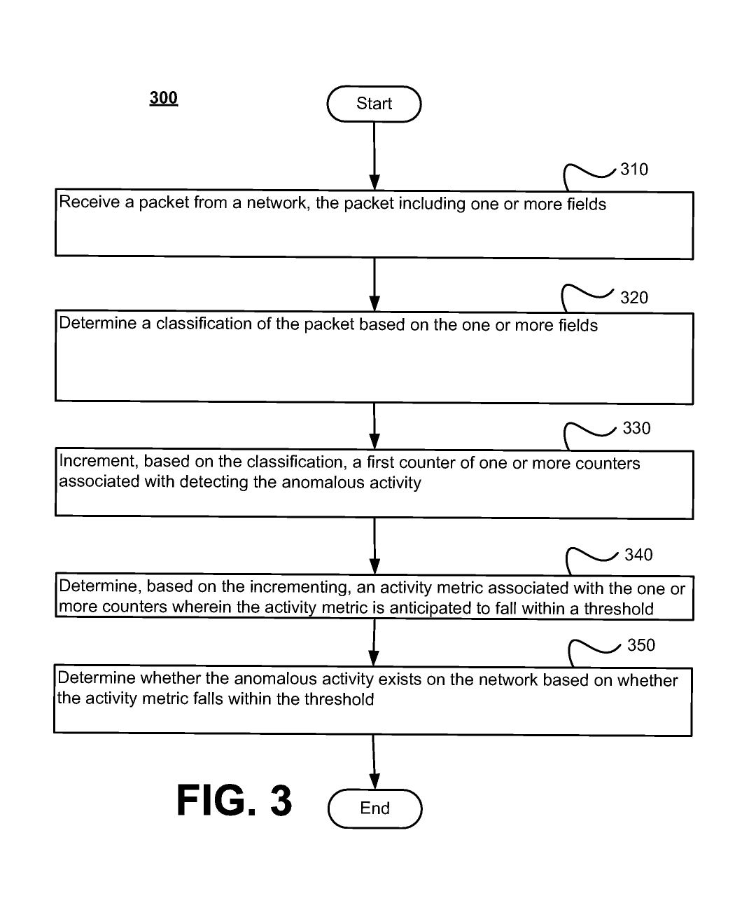

FIG. 3 is a flowchart 300 illustrating example operations of the system of FIG. 1. More specifically, FIG. 3 illustrates an operational flow 300 representing example operations related to network activity anomaly detection. While FIG. 3 illustrates an example operational flow 300 representing example operations related to the system 100 of FIG. 1, it should be appreciated that the operational flow 300 is not limited to the example of system 100 and may be applied to other systems.

After a start operation, at block 310, a packet may be received from a network, the packet including one or more fields. For example, in FIG. 1, the packet 102 may be received from the network 104. The packet 102 may include the fields 110 which may be determined by the parser 108.

At block 320, a classification of the packet may be determined based on the one or more fields. The classification engine 112 may determine the classification 114 of the packet 102 based on the fields 110. For example, the classification engine 112 may determine the classification 114 based on a comparison of one or more of the fields 110 to the classification rules 116.

At block 330, based on the classification, a first counter of one or more counters associated with detecting anomalous activity on the network may be incremented. For example, the counter 124A may be associated with the classification 114. Then for example, the counter 124A of the counters 124 may be incremented based on the classification 114 of the packet 102.

At block 340, based on the incrementing, an activity metric associated with the one or more counters may be determined wherein the activity metric is anticipated to fall within a threshold. For example, the activity engine 128 may determine the activity metric 130 based on the counters 124A and 124B, wherein the counter 124B is associated with the counter 124A. Then, for example, the activity metric 130 may be anticipated to fall within the threshold 134.

At block 350, it may be determined whether or not anomalous activity exists on the network based on whether the activity metric falls within the threshold. For example, the comparison logic 132 may determine whether or not anomalous activity exists on the network 104 based on a comparison of the activity metric 130 to the threshold 134. For example, if the activity metric 130 falls outside the threshold 134, the comparison logic 132 may determine that anomalous activity exists on the network 104.

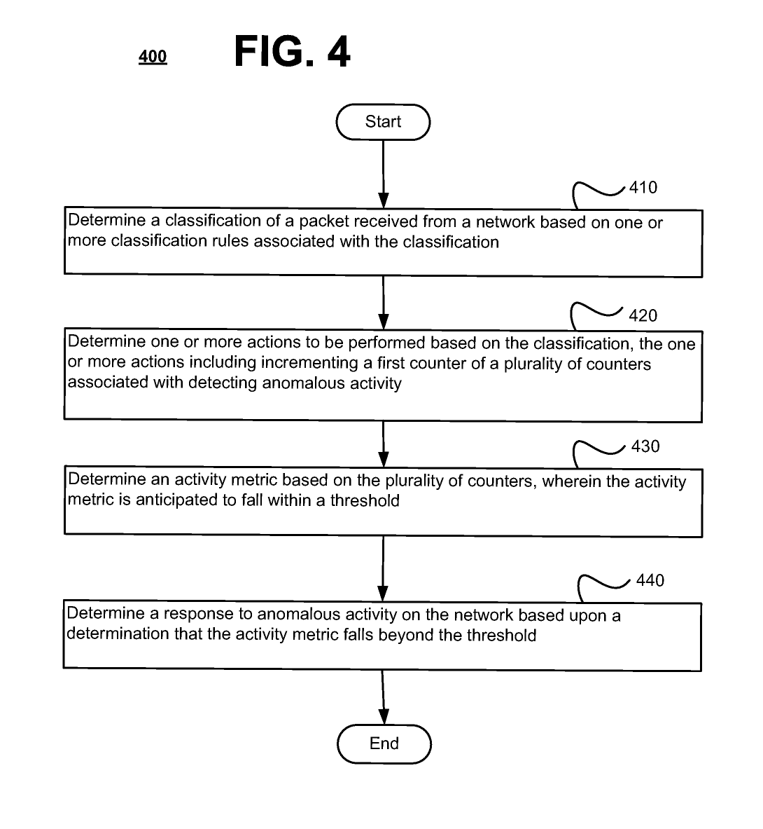

FIG. 4 is a flowchart 400 illustrating example operations of the system of FIG. 1. More specifically, FIG. 4 illustrates an operational flow 400 representing example operations related to network activity anomaly detection. While FIG. 4 illustrates an example operational flow 400 representing example operations related to the system 100 of FIG. 1, it should be appreciated that the operational flow 400 is not limited to the example of system 100 and may be applied to other systems.

After a start operation, at block 410, a classification of a packet received from a network may be determined based on one or more rules associated with the classification. For example, in FIG. 1, the packet 102 may be received from the network 104. Then for example, the classification engine 112 may determine the classification 114 of the packet 102 based on the classification rules 116.

At block 420, one or more actions to be performed based on the classification may be determined, the one or more actions including incrementing a first counter of a plurality of counters associated with detection of anomalous activity. For example, the action logic 118 may determine which of the actions 122 are to be performed based on the classification 114. Then for example, the actions 122 may include any number of different actions, including incrementing the counter 124A of the counters 124, wherein the counter 124A and 124B are associated with detecting anomalous activity on the network 104.

At block 430, an activity metric may be determined based on the plurality of counters, wherein the activity metric is anticipated to fall within a threshold. For example, the monitor 126 may determine that the counter 124A was incremented. Then for example, the activity engine 128 may retrieve the values of the counter 124A and associated counter 124B to generate the activity metric 130, wherein the activity metric may be anticipated to fall within the threshold 134.

At block 440, a response to anomalous activity on the network may be determined based on a determination that the activity metric falls beyond the threshold. For example, the comparison logic 132 may determine that anomalous activity exists on the network 104 based on a determination that the activity metric 130 falls beyond the threshold 134. Then, for example, the response module 136 may determine and/or execute a response 138A, from the responses 138, to the anomalous activity on the network 104.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A method for determining whether anomalous activity exists on a network, comprising:
receiving a packet from the network, the packet including one or more fields;
determining a classification of the packet based on the one or more fields;
incrementing, based on the classification, a first counter of one or more counters associated with detecting the anomalous activity;
determining, based on the incrementing, an activity metric associated with the one or more counters wherein the activity metric is anticipated to fall within a threshold; and
determining whether the anomalous activity exists on the network based on whether the activity metric falls within the threshold.

2. The method of claim 1, wherein determining the classification comprises comparing the one or more fields to one or more classification rules associated with the classification.

3. The method of claim 1 wherein, incrementing the first counter comprises:
receiving a first packet from the network, the first packet being associated with a first classification;
receiving a second packet from the network, the second packet being associated with the first classification;
determining a rate between the receiving the first packet and the receiving the second packet; and
tracking the rate via the first counter.

4. The method of claim 1, wherein incrementing the first counter comprises signaling the first counter to increment.

5. The method of claim 1, wherein incrementing the counter comprises:
determining, based on the classification, that the first counter is associated with the packet; and
incrementing the first counter.

6. The method of claim 1, wherein determining the activity metric comprises determining a difference between two or more of the counters.

7. The method of claim 1, wherein determining the activity metric comprises determining a ratio between two or more of the counters.

8. The method of claim 1, wherein the determining, based on the incrementing the activity metric comprises determining a ratio between a first counter incremented based on a receipt of a first transmission control packet and a second counter incremented based on a receipt of a second transmission control packet.

9. The method of claim 1, further comprising determining a response to the anomalous activity based on a determination that the activity metric exceeds the threshold.

10. The method of claim 1 comprising:
hashing the one or more fields of the packet to determine the classification, wherein the classification is associated with a flow of one or more packets comprising similar values in the one or more fields; and
incrementing, based on the classification, the first counter associated with the flow.

11. A network device associated comprising:
a parser configured to parse a packet into one or more fields;
a classification module configured to determine a classification of the packet based on the one or more fields;
an action table including the classification of the packet and one or more corresponding actions;
a monitor configured to determine when a counter is incremented based on the corresponding actions, wherein the counter is associated with a set of one or more counters;
an activity engine configured to determine, based on the set of one or more counters and including the incremented counter, an activity metric associated with the packet; and
comparison logic configured to determine whether anomalous activity exists on the network based on a comparison of the activity metric to a threshold associated with the anomalous activity.

12. The network device of claim 11, wherein the parser is configured to receive the packet.

13. The network device of claim 11, wherein the classification module is configured to compare the one or more fields to one or more rules associated with classifying the packet.

14. The network device of claim 13, wherein the one or more rules correspond to one or more of the actions.

15. The network device of claim 11, wherein the action table comprises one or more rules associated with the classification of the packet and the one or more corresponding actions.

16. The network device of claim 11, wherein the monitor is configured to determine which of a plurality of counters is included in the set of one or more counters.

17. The network device of claim 11, wherein the activity engine is configured to:
retrieve values from each of the set one or more counters associated with the incremented counter, including the incremented counter; and
compute the activity metric based on the retrieved values.

18. The network device of claim 11, further comprising a response module configured to determine a response to the anomalous activity based on the comparison of the activity metric to the threshold.

19. A computer program product for detecting anomalous activity on a network, the computer program product being tangibly embodied on a computer-readable medium configured to cause a data processing apparatus to detect the anomalous activity on the network, the computer program product configured to:
determine a classification of a packet received from the network based on one or more classification rules associated with the classification;
determine one or more actions to be performed based on the classification, the one or more actions including incrementing a first counter of a plurality of counters associated with detecting the anomalous activity;
determine an activity metric based on the plurality of counters, wherein the activity metric is anticipated to fall within a threshold; and
determine a response to the anomalous activity based upon a determination that the activity metric falls beyond the threshold.

20. The computer program product of claim 19, wherein the computer program product is configured to determine the response to the anomalous activity, wherein the response is anticipated to offset at least a portion of the anomalous activity.
